(19) United States
(12) Patent Application Publication
(10) Pub. No.: US 2026/0044052 A1
(43) Pub. Date: Feb. 12, 2026

(54) CAMERA MODULE AND ELECTRONIC DEVICE INCLUDING CAMERA MODULE

(71) Applicant: Samsung Electronics Co., Ltd., Suwon-si (KR)

(72) Inventors: Kwangseok BYON, Suwon-si (KR); Jaekyu SHIM, Suwon-si (KR); Hyosang AN, Suwon-si (KR)

(21) Appl. No.: 19/322,074

(22) Filed: Sep. 8, 2025

Related U.S. Application Data
(63) Continuation of application No. PCT/KR2025/012132, filed on Aug. 11, 2025.

(30) Foreign Application Priority Data
Aug. 12, 2024 (KR) 10-2024-0107805
Oct. 11, 2024 (KR) 10-2024-0138210

(51) Int. Cl. G03B 13/36; G02B 27/00; G02B 27/64; G03B 5/04; G03B 17/17

(52) U.S. Cl. CPC G03B 13/36; G02B 27/0006; G02B 27/646; G03B 5/04; G03B 17/17; G03B 2205/0015; G03B 2205/0069

(57) ABSTRACT

A camera module may include a reflective member including an incident surface and an exit surface through which light introduced into the incident surface passes, a bracket where the reflective member is disposed, a camera housing including a support where at least a portion of the bracket is disposed, and a side wall perpendicular to the support portion, a first carrier disposed in the camera housing and at least partially facing the bracket, a lens assembly including at least one lens facing the incident surface of the reflective member, the lens assembly being disposed in the first carrier such that the lens is spaced apart from the reflective member in an optical axis direction of the lens, a cover including an opening configured to accommodate a portion of the lens assembly, the cover being coupled to the camera housing, an image sensor disposed on the camera housing, and configured to receive light that has passed through the exit surface of the reflective member, a foreign substance trap, at least a portion of which is disposed between the image sensor and the lens assembly when the cover member is viewed from above, and an adhesive disposed in the foreign substance trapping portion.

### CROSS-REFERENCE TO RELATED APPLICATIONS

This application is a continuation of International Application No. PCT/KR2025/012132 designating the United States, filed on Aug. 11, 2025, in the Korean Intellectual Property Receiving Office and claiming priority to Korean Patent Application Nos. 10-2024-0107805, filed on Aug. 12, 2024, and 10-2024-0138210, filed on Oct. 11, 2024, in the Korean Intellectual Property Office, the disclosures of each of which are incorporated by reference herein in their entireties.

### BACKGROUND

### Field

The disclosure relates to a camera module and an electronic device including the camera module.

### Description of Related Art

Various electronic devices, such as a smartphone, a tablet PC, a portable multimedia player (PMP), a personal digital assistant (PDA), a laptop personal computer (PC), such as a wrist watch or a head-mounted display (HMD), may include a camera and may capture an image using the camera.

As the number of users capturing photos or videos using electronic devices increases, the performance of cameras included in electronic devices is also improving. For example, when capturing an image using a camera included in an electronic device, in order to obtain a clear image, it may be necessary to adjust the focus of the subject or to compensate for shaking (e.g., hand tremor) that may occur when taking a picture of the subject.

A camera module used in an electronic device may include an autofocus (AF) function that automatically adjusts the focus of a lens on a subject and/or an optical image stabilizer (OIS) function that compensates for shaking occurring in the camera module when taking a picture of a subject. The AF function and the OIS function of the camera module may be driven based on electromagnetic force using a magnet and a coil.

The above-described information may be provided as related art for the purpose of assisting in understanding the disclosure. No assertion or claim is made as to whether any of the above might be applicable as prior art with regard to the disclosure.

### SUMMARY

According to an example embodiment of the disclosure, a camera module may include: a reflective member comprising a reflective surface including an incident surface and an exit surface configured to pass light introduced into the incident surface. The camera module may include a bracket where the reflective member is disposed. The camera module may include a camera housing including a support where at least a portion of the bracket is disposed, and a side wall perpendicular to the support. The camera module may include a first carrier disposed in the camera housing and at least partially facing the bracket. The camera module may include a lens assembly including at least one lens facing the incident surface of the reflective member. The lens assembly is disposed in the first carrier such that the lens is spaced apart from the reflective member in an optical axis direction of the lens. The camera module may include a cover coupled to the camera housing and including an opening configured to accommodate a portion of the lens assembly. The camera module may include an image sensor disposed in the camera housing and configured to receive light that has passed through the exit surface of the reflective member. The camera module may include a foreign substance trap, at least a portion of which is disposed between the image sensor and the lens assembly when the cover member is viewed from above. The camera module may include an adhesive member comprising an adhesive material disposed in the foreign substance trap.

According to an example embodiment of the disclosure, in an electronic device including a camera module, the camera module may include: a reflective member comprising a reflective material including an incident surface and an exit surface configured to pass light introduced into the incident surface. The camera module may include a bracket where the reflective member is disposed. The camera module may include a camera housing including a support where at least a portion of the bracket is disposed, and a side wall perpendicular to the support portion. The camera module may include a first carrier disposed in the camera housing and at least partially facing the bracket. The camera module may include a lens assembly including at least one lens facing the incident surface of the reflective member. The lens assembly is disposed in the first carrier such that the lens is spaced apart from the reflective member in an optical axis direction of the lens. The camera module may include a cover coupled to the camera housing and including an opening configured to accommodate a portion of the lens assembly. The camera module may include an image sensor disposed in the camera housing and configured to receive light that has passed through the exit surface of the reflective member. The camera module may include a foreign substance trap, at least a portion of which is disposed between the image sensor and the lens assembly when the cover member is viewed from above. The camera module may include an adhesive member comprising an adhesive disposed in the foreign substance trap.

### BRIEF DESCRIPTION OF THE DRAWINGS

With regard to the description of the drawings, the same or like reference signs may be used to designate the same or like elements. Additionally, the above and other aspects, features and advantages of certain embodiments of the present disclosure will be more apparent from the following detailed description, taken in conjunction with the accompanying drawings, in which:

FIG. 1 is a block diagram illustrating an example electronic device in a network environment according to various embodiments;

FIG. 2 is a block diagram illustrating an example configuration of a camera module according to various embodiments;

FIG. 3A is a perspective view of a camera module according to various embodiments;

FIG. 3B is a diagram illustrating a front view of the camera module according to various embodiments;

FIG. 4 is an exploded perspective view of the camera module illustrated in FIGS. 3A and 3B according to various embodiments;

FIG. 5 is a perspective view of a first carrier including a foreign substance trapping portion (e.g., foreign substance trap) according to various embodiments;

FIG. 6 is a cross-sectional view taken along P1-P1 of FIG. 3B according to various embodiments;

FIG. 7 is a cross-sectional view illustrating the first carrier being movable in an optical axis direction with respect to a second carrier, and the second carrier being movable in a direction perpendicular to the optical axis with respect to the camera housing according to various embodiments;

FIG. 8 is a perspective view of a camera module according to various embodiments;

FIG. 9 is an exploded perspective view of the camera module illustrated in FIG. 8 according to various embodiments;

FIG. 10 is a perspective view of a bracket where a reflective member is disposed and which includes a foreign substance trapping portion according to various embodiments; and

FIG. 11 is a cross-sectional view taken along P2-P2 of FIG. 8 according to various embodiments.

### DETAILED DESCRIPTION

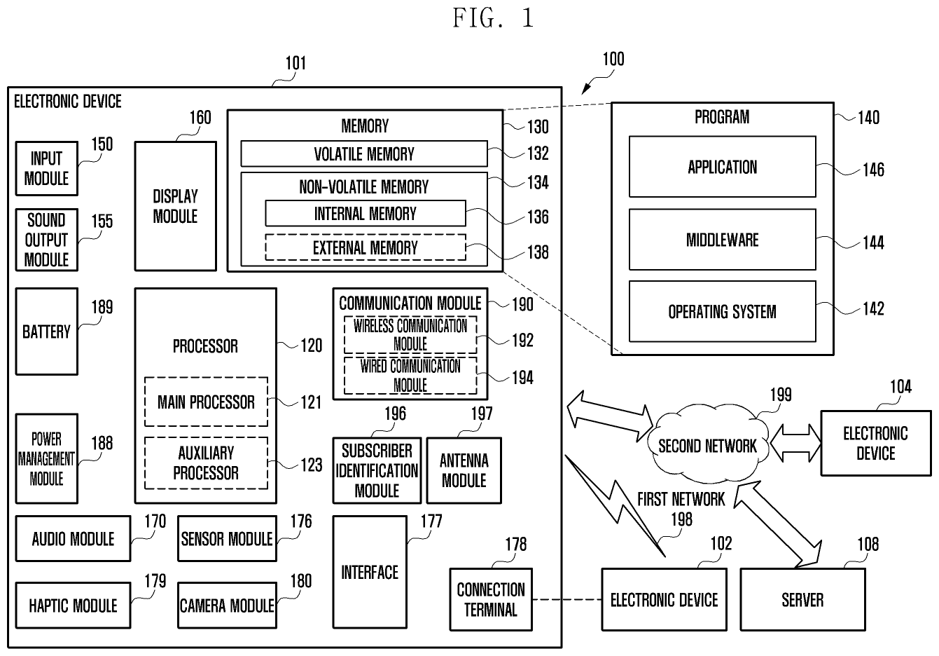

FIG. 1 is a block diagram illustrating an example electronic device 101 in a network environment 100 according to various embodiments. Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In various embodiments, at least one of the components (e.g., the connecting terminal 178) may be omitted from the electronic device 101, or one or more other components may be added in the electronic device 101. In various embodiments, some of the components (e.g., the sensor module 176, the camera module 180, or the antenna module 197) may be implemented as a single component (e.g., the display module 160).

The processor 120 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions. The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element including a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

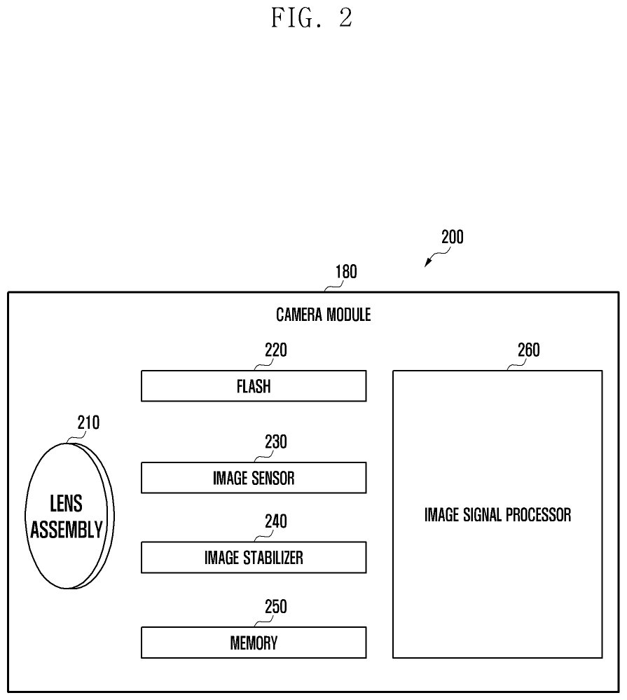

FIG. 2 is a block diagram 200 illustrating the camera module 180 according to various embodiments. Referring to FIG. 2, the camera module 180 may include a lens assembly (e.g., including a lens) 210, a flash 220, an image sensor 230, an image stabilizer (e.g., including circuitry) 240, memory 250 (e.g., buffer memory), and/or an image signal processor (e.g., including image processing circuitry) 260. The lens assembly 210 may collect light emitted or reflected from an object whose image is to be taken. The lens assembly 210 may include one or more lenses. According to an embodiment, the camera module 180 may include a plurality of lens assemblies 210. In such a case, the camera module 180 may form, for example, a dual camera, a 360-degree camera, or a spherical camera. Some of the plurality of lens assemblies 210 may have the same lens attribute (e.g., view angle, focal length, auto-focusing, f number, or optical zoom), or at least one lens assembly may have one or more lens attributes different from those of another lens assembly. The lens assembly 210 may include, for example, a wide-angle lens or a telephoto lens.

The flash 220 may emit light that is used to reinforce light reflected from an object. According to an embodiment, the flash 220 may include one or more light emitting diodes (LEDs) (e.g., a red-green-blue (RGB) LED, a white LED, an infrared (IR) LED, or an ultraviolet (UV) LED) or a xenon lamp. The image sensor 230 may obtain an image corresponding to an object by converting light emitted or reflected from the object and transmitted via the lens assembly 210 into an electrical signal. According to an embodiment, the image sensor 230 may include one selected from image sensors having different attributes, such as a RGB sensor, a black-and-white (BW) sensor, an IR sensor, or a UV sensor, a plurality of image sensors having the same attribute, or a plurality of image sensors having different attributes. Each image sensor included in the image sensor 230 may be implemented using, for example, a charged coupled device (CCD) sensor or a complementary metal oxide semiconductor (CMOS) sensor.

The image stabilizer 240 may include various circuitry and move the image sensor 230 or at least one lens included in the lens assembly 210 in a particular direction, or control an operational attribute (e.g., adjust the read-out timing) of the image sensor 230 in response to the movement of the camera module 180 or the electronic device 101 including the camera module 180. This allows compensating for at least part of a negative effect (e.g., image blurring) by the movement on an image being captured. According to an embodiment, the image stabilizer 240 may sense such a movement by the camera module 180 or the electronic device 101 using a gyro sensor (not shown) or an acceleration sensor (not shown) disposed inside or outside the camera module 180. According to an embodiment, the image stabilizer 240 may be implemented, for example, as an optical image stabilizer. The memory 250 may store, at least temporarily, at least part of an image obtained via the image sensor 230 for a subsequent image processing task. For example, if image capturing is delayed due to shutter lag or multiple images are quickly captured, a raw image obtained (e.g., a Bayer-patterned image, a high-resolution image) may be stored in the memory 250, and its corresponding copy image (e.g., a low-resolution image) may be previewed via the display module 160. Thereafter, if a specified condition is met (e.g., by a user's input or system command), at least part of the raw image stored in the memory 250 may be obtained and processed, for example, by the image signal processor 260. According to an embodiment, the memory 250 may be configured as at least part of the memory 130 or as a separate memory that is operated independently from the memory 130.

The image signal processor 260 may include various image signal processing circuitry and perform one or more image processing with respect to an image obtained via the image sensor 230 or an image stored in the memory 250. The one or more image processing may include, for example, depth map generation, three-dimensional (3D) modeling, panorama generation, feature point extraction, image synthesizing, or image compensation (e.g., noise reduction, resolution adjustment, brightness adjustment, blurring, sharpening, or softening). Additionally or alternatively, the image signal processor 260 may perform control (e.g., exposure time control or read-out timing control) with respect to at least one (e.g., the image sensor 230) of the components included in the camera module 180. An image processed by the image signal processor 260 may be stored back in the memory 250 for further processing, or may be provided to an external component (e.g., the memory 130, the display module 160, the electronic device 102, the electronic device 104, or the server 108) outside the camera module 180. According to an embodiment, the image signal processor 260 may be configured as at least part of the processor 120, or as a separate processor that is operated independently from the processor 120. If the image signal processor 260 is configured as a separate processor from the processor 120, at least one image processed by the image signal processor 260 may be displayed, by the processor 120, via the display module 160 as it is or after being further processed.

According to an embodiment, the electronic device 101 may include a plurality of camera modules 180 having different attributes or functions. In such a case, at least one of the plurality of camera modules 180 may form, for example, a wide-angle camera and at least another of the plurality of camera modules 180 may form a telephoto camera. Similarly, at least one of the plurality of camera modules 180 may form, for example, a front camera and at least another of the plurality of camera modules 180 may form a rear camera.

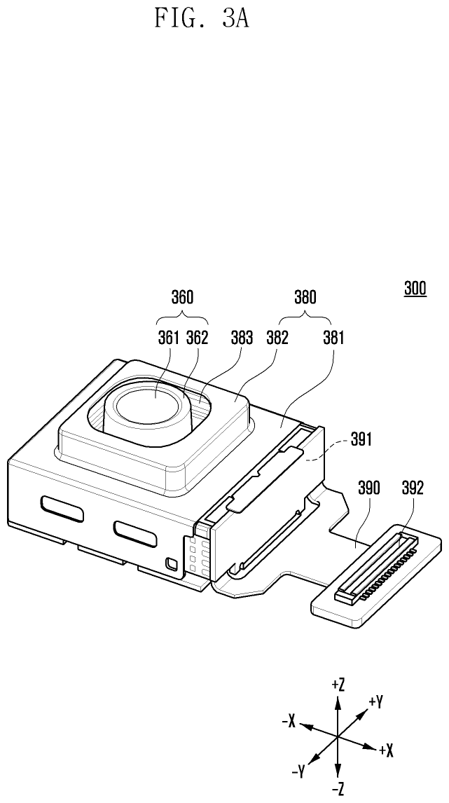

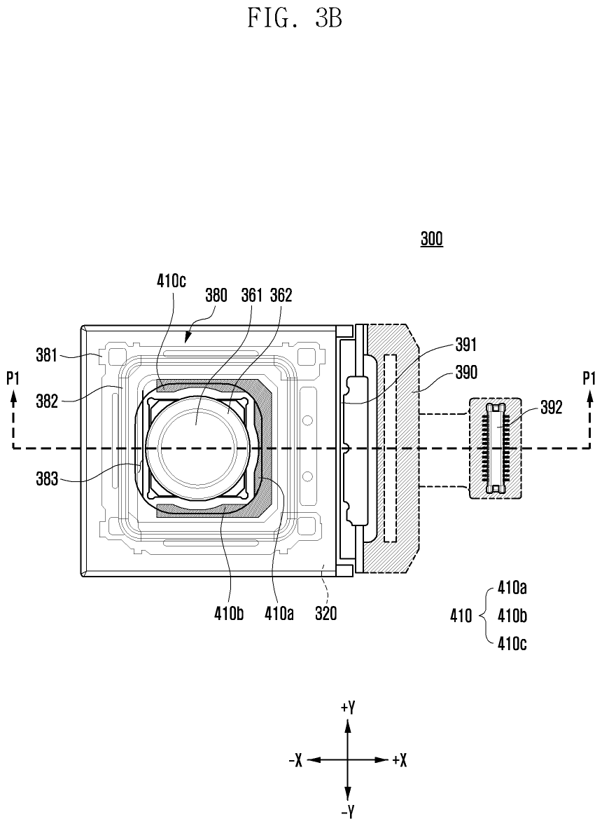

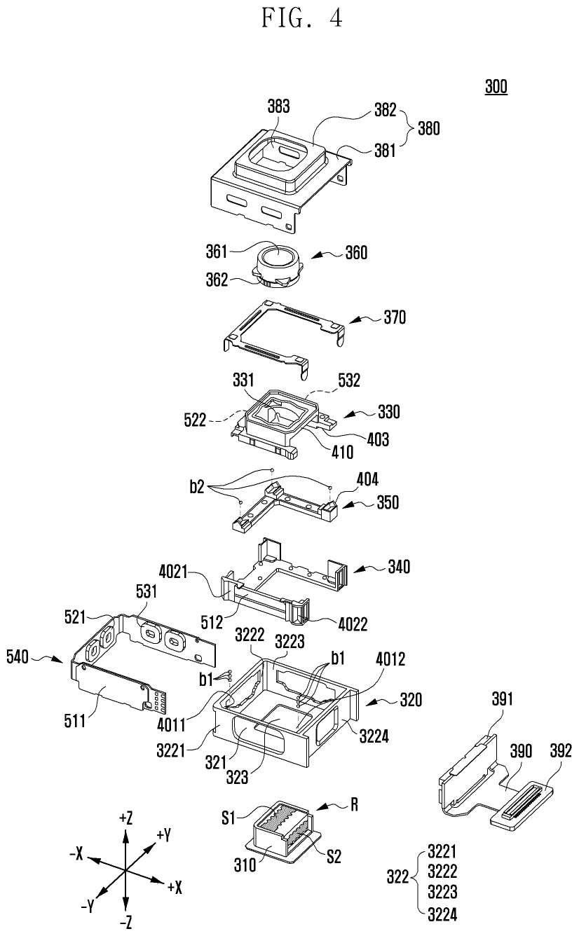

FIG. 3A is a perspective view of a camera module according to various embodiments. FIG. 3B is a diagram illustrating a front view of the camera module according to various embodiments. FIG. 4 is an exploded perspective view of the camera module illustrated in FIGS. 3A and 3B according to various embodiments.

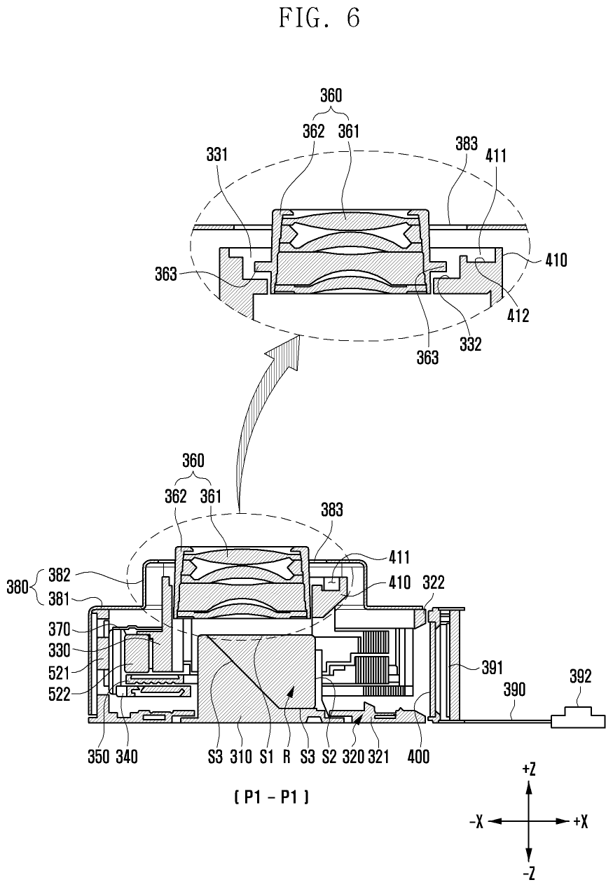

According to an embodiment of the disclosure, as illustrated in FIG. 3A, FIG. 3B, and FIG. 4, a camera module 300 (e.g., the camera module 180 in FIG. 1) may include a bracket 310 where a reflective member R is accommodated, a camera housing 320, a first carrier 330 (e.g., a first housing, a first bracket 310, or an OIS carrier), a second carrier 340 (e.g., a second housing, a second bracket 310, or an AF carrier), a middle guide 350 (e.g., a guide member), a lens assembly 360, a stopper 370, a cover member 380 (e.g., a shield can), an image sensor 391 (e.g., the image sensor 230 in FIG. 2), an IR filter 400 (e.g., the IR filter 400 in FIG. 6), an AF actuator (e.g., an AF magnetic body 512 and an AF coil 511), a first OIS actuator (e.g., a first OIS magnetic body 522 and a first OIS coil 521), a second OIS actuator (e.g., a second OIS magnetic body 532 and a second OIS coil 531), a flexible printed circuit board (FPCB) 540, a plurality of AF balls b1, and/or a plurality of OIS balls b2. At least one of the above-described components may be omitted, or other components may be added.

According to an embodiment, as illustrated in FIG. 4, the camera module 300 may include a first carrier 330 and a second carrier 340 disposed inside the camera housing 320. The first carrier 330 may be disposed inside the second carrier 340 while accommodating the lens assembly 360. In an embodiment, the camera housing 320 may have an open top surface to allow the second carrier 340 to be inserted and may provide a space to allow the second carrier 340 to be seated therein. In an embodiment, the second carrier 340 may have an open top surface to allow the first carrier 330 to be inserted and may provide a space to allow the first carrier 330 to be seated therein. In an embodiment, the first carrier 330 may include a receiving groove 331 into which the lens assembly 360 is inserted. In an embodiment, the lens assembly 360 may be inserted into the receiving groove 331 of the first carrier 330 and fixed inside the first carrier 330.

In an embodiment, referring to FIG. 4, the lens assembly 360 (e.g., a lens assembly or a lens module) may include at least one lens 361 and a lens barrel 362 (e.g., a barrel) where the lens 361 is disposed. In an embodiment, the lens assembly 360 may be disposed in the second carrier 340 in the state of being coupled to the first carrier 330. In an embodiment, the lens assembly 360 may be arranged such that the lens 361 is spaced apart from the incident surface S1 of the reflective member R in the +Z direction of FIG. 4. In an embodiment, at least a portion of the lens assembly 360 may be positioned in the opening 383 of the cover member 380 (e.g., a shield can) and may be visually exposed outside the camera module 300.

In an embodiment, referring to FIG. 4 and FIG. 6 to be described in greater detail below, the first carrier 330 may be disposed in the second carrier 340 in the state in which the lens assembly 360 is accommodated therein. In an embodiment, the first carrier 330 may be an OIS (optical image stabilizer) driver. In an embodiment, the first carrier 330 may move in a first axis direction perpendicular to the optical axis (e.g., the X-axis or Y-axis direction of FIG. 4) and/or in a second axis direction perpendicular to the first axis direction (e.g., the X-axis or Y-axis direction of FIG. 4) with respect to a counterpart (e.g., the camera housing 320 and the second carrier 340) as the processor 120 controls the OIS actuator (e.g., a first OIS actuator (e.g., a first OIS coil 521 and a first OIS magnetic body 522) and/or a second OIS actuator (e.g., a second OIS coil 531 and a second OIS magnetic body 532)), thereby performing image stabilization.

In an embodiment, the reflective member R may include a configuration that refracts or reflects a light path, such as a prism or a mirror. In an embodiment, referring to FIG. 4, the reflective member R may include an incident surface S1 on which light is incident, a reflective surface S3 on which light is reflected or refracted, and an exit surface S2 through which light introduced into the incident surface S1 exits. In an embodiment, the incident surface S1 of the reflective member R may face the lens 361 of the lens assembly 360. Light introduced from outside the camera module 300 may pass through the lens 361 of the lens assembly 360, the incident surface S1 of the reflective member R, and the exit surface S2 of the reflective member R, and may be introduced into the image sensor 391 disposed on a portion of the camera housing 320 (e.g., the side wall portion 322) so as to face the exit surface S2 of the reflective member R. In an embodiment, light introduced into the incident surface S1 of the reflective member R may be refracted by about 90 degrees through the reflective surface S3 and emitted through the exit surface S2 to be introduced into the image sensor 391.

In an embodiment, the reflective member R may be configured in various shapes. In an embodiment, referring to FIG. 6 to be described in greater detail below, the cross-section of the reflective member R may be trapezoidal. In an embodiment, the cross-section of the reflective member R may be triangular, in which the incident surface S1 and the exit surface S2 form a right angle. In addition, the reflective member R may be modified into various shapes according to use conditions so that light introduced into the lens 361 is refracted and delivered to the image sensor 391. In an embodiment, the reflective member R may include a mirror. In this case, the incident surface and the exit surface may be defined as virtual surfaces rather than the physical surfaces of a mirror.

According to an embodiment of the disclosure, an additional reflective member (not illustrated) may be disposed between the reflective member R and the side wall portion 322 of the camera housing 320. In an embodiment, the additional reflective member may include an incident surface on which light is incident, a reflective surface on which light is reflected or refracted, and an exit surface through which light introduced into the incident surface exits. In an embodiment, the incident surface and the exit surface of the additional reflective member may be substantially perpendicular to each other. In an embodiment, the additional reflective member may have a trapezoidal cross-section or a triangular cross-section in which the incident surface and the exit surface form a right angle, and may also have various other shapes. In an embodiment, the incident surface of the additional reflective member may face the exit surface S2 of the reflective member R. The exit surface of the additional reflective member may face the image sensor 391. In an embodiment, when the incident surface and the exit surface of the additional reflective member are substantially perpendicular to each other, the image sensor 391 may be disposed on the support portion 321 of the camera housing 320 or on a portion facing the support portion 321 (e.g., a surface of the camera housing 320) so as to face the exit surface of the additional reflective member. Accordingly, light introduced from outside the camera module 300 may pass through the lens 361 of the lens assembly 360, the incident surface S1 of the reflective member R, the exit surface S2 of the reflective member R, the incident surface of the additional reflective member, and the exit surface of the additional reflective member, and may be introduced into the image sensor 391 disposed on a portion of the camera housing 320 (e.g., the support portion 321) so as to face the exit surface of the additional reflective member.

In an embodiment, referring to FIG. 4, the reflective member R may be seated on the bracket 310. In an embodiment, the bracket 310 may include a seating groove having a shape corresponding to the reflective member R. In an embodiment, the reflective member R may be disposed on the bracket 310 such that the inclined surface located in the seating groove faces the reflective surface S3.

In an embodiment, referring to FIG. 4 and FIG. 6 to be described in greater detail below, the camera housing 320 may accommodate the bracket 310 where the reflective member R is disposed, the second carrier 340, the middle guide 350, the first carrier 330, the lens assembly 360, and the stopper 370.

In an embodiment, referring to FIG. 4, the camera housing 320 may include a support portion 321 (e.g., a support surface) where the second carrier 340 is disposed, and a side wall portion 322 (e.g., a side surface portion or a partition wall portion) substantially perpendicular to the support portion 321. As will be described in greater detail below, the side wall portion 322 of the camera housing 320 may be provided along the periphery of the support portion 321. In an embodiment, the side wall portion 322 may include a first portion 3221, a second portion 3222, a third portion 3223, and/or a fourth portion 3224. In an embodiment, the first portion 3221 and the third portion 3223 may face each other, and the second portion 3222 and the fourth portion 3224 may face each other. The first portion 3221 and the second portion 3222 may be perpendicular to each other, and the third portion 3223 and the fourth portion 3224 may be perpendicular to each other.

In an embodiment, referring to FIG. 4, an AF coil 511 may be disposed in the first portion 3221 of the camera housing 320. In an embodiment, a first OIS coil 521 may be disposed in the second portion 3222. In an embodiment, a second OIS coil 531 may be disposed in the third portion 3223. In an embodiment, the AF coil 511, the first OIS coil 521, and the second OIS coil 531 may not be limited to the above positions and may be disposed in various portions of the camera housing 320. In an embodiment, the fourth portion 3224 of the camera housing 320 may face the exit surface S2 of the reflective member R. In an embodiment, the image sensor 391 may be disposed in the fourth portion 3224 of the camera housing 320 to allow the light, which has exited from the exit surface S2 of the reflective member R, to be introduced into the image sensor.

In an embodiment, referring to FIG. 4, the camera housing 320 may include an opening 323 that allows the bracket 310 to be inserted. In an embodiment, the opening 323 of the camera housing 320 may be provided in the support portion 321. In an embodiment, the bracket 310 may be inserted into the opening 323 of the camera housing 320 and fixed to the camera housing 320.

In an embodiment, referring to FIG. 4, the second carrier 340 may be disposed in the camera housing 320 and may face the support portion 321 of the camera housing 320. In an embodiment, the second carrier 340 may be disposed in the camera housing 320 so as to surround the bracket 310 fixed to the support portion 321 of the camera housing 320. In an embodiment, as will be described with reference to FIGS. 3A to 6, the second carrier 340 may be an autofocus (AF) driver. In an embodiment, as the processor 120 controls the AF actuator (e.g., an AF coil 511 and an AF magnetic body 512), the second carrier 340 may perform an AF function of automatically adjusting the focus of the lens 361 on a subject by moving in the optical axis direction of the lens 361 (e.g., the Z-axis direction of FIG. 4) with respect to the camera housing 320.

In an embodiment, referring to FIG. 4, the middle guide 350 may be disposed between the first carrier 330 and the second carrier 340. In an embodiment, the middle guide 350 may prevent or suppress the first carrier 330 from rotating with respect to the optical axis (e.g., a roll axis or the Z-axis in FIG. 4) with respect to the camera housing 320 or the second carrier 340 when the first carrier 330 moves with respect to the second carrier 340 along a first axis (e.g., the X-axis or Y-axis) and/or a second axis (e.g., the Y-axis or X-axis) for image stabilization, or when an external impact is applied to the camera module 300.

In an embodiment, referring to FIG. 4, the stopper 370 may be coupled to the second carrier 340 to prevent or suppress the first carrier 330 from separating from the second carrier 340. For example, the stopper 370 may prevent or suppress the first carrier 330 from lifting or separating in the +Z direction of FIG. 4 with respect to the second carrier 340.

In an embodiment, referring to FIG. 4, the cover member 380 (e.g., a shield can) may be positioned at the outermost area of the camera module 300 and may cover at least a portion of the camera housing 320. In an embodiment, the cover member 380 may include a material that shields electromagnetic waves generated outside the camera module 300. In an embodiment, the cover member 380 may block or reduce electromagnetic waves generated outside the camera module 300, thereby reducing the occurrence of malfunctions of the camera module 300.

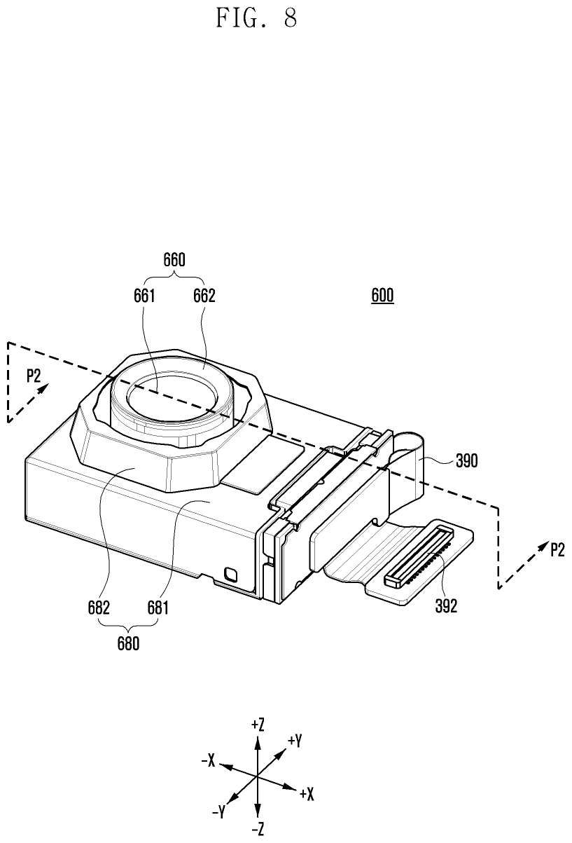

In an embodiment, referring to FIGS. 3A, 3B, and 4, the cover member 380 may have a two-step shape. In an embodiment, the cover member (e.g., cover) 380 may include a first cover portion 381 coupled to the camera housing 320 and a second cover portion 382 protruding from the first cover portion 381. In an embodiment, the first cover portion 381 and the second cover portion 382 may be integrally formed through an injection molding process. As with the camera module 600 of FIG. 8 to be described in greater detail below, the cover member 380 may be formed such that after the first cover portion 381 is formed, the second cover portion 382 is formed on the first cover portion 381 through a separate insert injection molding process. In this case, the first cover portion 381 and the second cover portion 382 may be formed of different materials, but they may also be formed of the same material.

In an embodiment, the second cover portion 382 may protrude in the +Z direction relative to the first cover portion 381, based on FIG. 3A, and may be formed along the periphery of the lens assembly 360 to include an opening 383 configured to accommodate at least a portion of the lens assembly 360. In an embodiment, the second cover portion 382 may be configured to surround the lens assembly 360 so as to prevent or block light introduced toward the lens 361 from being directly introduced into the image sensor 391. In an embodiment, the second cover portion 382 may prevent or block external foreign substances (e.g., dust or fluid) of the camera module 300 from being introduced into the image sensor 391.

According to an embodiment, the camera module 300 may adjust focus by moving the second carrier 340 in the optical axis direction (e.g., the Z-axis direction of FIG. 4) with respect to the camera housing 320 under the control of the processor 120. In an embodiment, the second carrier 340 may move in the optical axis direction of the lens 361 (e.g., the Z-axis direction of FIG. 4) through an AF actuator. In an embodiment, the AF actuator may include an AF coil 511 disposed in the first portion 3221 of the camera housing 320 and an AF magnetic body 512 disposed in the second carrier 340 to face the AF coil 511. In various embodiments, the AF coil 511 may be disposed in the second carrier 340, and the AF magnetic body 512 may be disposed in the camera housing 320. The second carrier 340 may perform an AF function of automatically adjusting the focus of the lens 361 on a subject by moving in the optical axis direction through an electromagnetic force acting between the AF coil 511 and the AF magnetic body 512. In an embodiment, the AF coil 511 may be electrically connected to a flexible printed circuit board 540 disposed in the camera housing 320. As the processor 120 controls a driving circuit (e.g., a driver IC) (not illustrated) of the camera module 300, a current generated in the driving circuit may be supplied to the AF coil 511 through the flexible printed circuit board 540 connected to the driving circuit. Accordingly, an electromagnetic effect is induced between the AF coil 511 and the AF magnetic body 512, and the second carrier 340 may move in the optical axis direction with respect to the camera housing 320.

In an embodiment, the AF magnetic body 512 may be disposed in the second carrier 340 such that an N pole and an S pole face the AF coil 511 disposed in the camera housing 320. In this case, the second carrier 340 may move in the optical axis direction with respect to the camera housing 320 while maintaining a vertical distance (e.g., the Y-axis direction distance of FIG. 4) between the AF coil 511 and the AF magnetic body 512.

In an embodiment not illustrated in the drawings, one of the AF coil 511 and the AF magnetic body 512 may be disposed on the rear surface of the second carrier 340 (e.g., the surface facing the support portion 321 of the camera housing 320), and the remaining one of the AF coil 511 and the AF magnetic body 512 may be disposed in the support portion 321 of the camera housing 320 so as to face one of the AF coil 511 and the AF magnetic body 512. For example, when the AF magnetic body 512 is disposed on the rear surface of the second carrier 340, the AF coil 511 may be disposed in the camera housing 320, and the opposite arrangement may also be possible. In an embodiment, the AF magnetic body 512 may be disposed in the second carrier 340 or the camera housing 320 such that one of the N pole and the S pole faces the AF coil 511. In this case, the AF magnetic body 512 may change a vertical distance with respect to the AF coil 511 through the electromagnetic force acting with the AF coil 511. Therefore, the second carrier 340 may perform an AF function of automatically adjusting the focus of the lens 361 on a subject by moving in the optical axis direction through an electromagnetic force acting between the AF coil 511 and the AF magnetic body 512.

According to an embodiment, the camera module 300 may perform image stabilization by moving the first carrier 330 with respect to the second carrier 340 under the control of the processor 120. In an embodiment, the electronic device 101 may perform image stabilization by moving the first carrier 330 in a direction opposite to the direction in which the camera module 300 is shaking. In an embodiment, the first carrier 330 may move in a first axis (e.g., the X-axis or Y-axis of FIG. 4) direction and/or a second axis (e.g., the Y-axis or X-axis of FIG. 4) direction substantially perpendicular to the optical axis with respect to the second carrier 340 through a first OIS actuator and a second OIS actuator.

In an embodiment, the first OIS actuator may include a first OIS coil 521 disposed in the second portion 3222 of the camera housing 320 and a first OIS magnetic body 522 disposed in the first carrier 330 to face the first OIS coil 521. In various embodiments, the first OIS coil 521 may be disposed in the first carrier 330, and the first OIS magnetic body 522 may be disposed in the camera housing 320. In an embodiment, the first carrier 330 may move in the first axis direction substantially perpendicular to the optical axis through an electromagnetic force acting between the first OIS coil 521 and the first OIS magnetic body 522. In an embodiment, the first OIS coil 521 may be electrically connected to a flexible printed circuit board 540 disposed in the camera housing 320. In an embodiment, the flexible printed circuit board 540 may wrap around the side wall portion 322 of the camera housing 320 (e.g., the first portion 3221, the second portion 3222, and the third portion 3223). As the processor 120 controls a driving circuit (e.g., a driver IC) (not illustrated) of the camera module 300, a current generated in the driving circuit may be supplied to the first OIS coil 521 through the flexible printed circuit board 540 connected to the driving circuit. Accordingly, an electromagnetic effect is induced between the first OIS coil 521 and the first OIS magnetic body 522, and the first carrier 330 may move in the first axis direction with respect to the second carrier 340 to perform an optical image stabilizer function for image stabilization.

In an embodiment, the second OIS actuator may include a second OIS coil 531 disposed in the third portion 3223 of the camera housing 320 and a second OIS magnetic body 532 disposed in the first carrier 330 to face the second OIS coil 531. In various embodiments, the second OIS coil 531 may be disposed in the first carrier 330, and the second OIS magnetic body 532 may be disposed in the camera housing 320. In an embodiment, the first carrier 330 may move in the second axis direction substantially perpendicular to the optical axis through an electromagnetic force acting between the second OIS coil 531 and the second OIS magnetic body 532. In an embodiment, the second OIS coil 531 may be electrically connected to a flexible printed circuit board 540 disposed in the camera housing 320. As the processor 120 controls a driving circuit (e.g., a driver IC) (not illustrated) of the camera module 300, a current generated in the driving circuit may be supplied to the second OIS coil 531 through the flexible printed circuit board 540 connected to the driving circuit. Accordingly, an electromagnetic effect is induced between the second OIS coil 531 and the second OIS magnetic body 532, and the first carrier 330 may move in the second axis direction with respect to the second carrier 340 to perform an optical image stabilizer function for image stabilization.

In an embodiment, the first OIS magnetic body 522 and the second OIS magnetic body 532 may be disposed in the first carrier 330 such that an N pole and an S pole respectively face the first OIS coil 521 and the second OIS coil 531 disposed in the camera housing 320. In this case, as the first OIS actuator (e.g., the first OIS magnetic body 522 and the first OIS coil 521) moves the first carrier 330 in the Y-axis direction of FIG. 4 with respect to the camera housing 320, the vertical distance (e.g., the X-axis direction distance of FIG. 4) between the first OIS magnetic body 522 and the first OIS coil 521 may not change. As the second OIS actuator (e.g., the second OIS magnetic body 532 and the second OIS coil 531) moves the first carrier 330 in the X-axis direction of FIG. 4 with respect to the camera housing 320, the vertical distance (e.g., the Y-axis direction distance of FIG. 4) between the first OIS magnetic body 522 and the first OIS coil 521 may not change.

In an embodiment, the first OIS magnetic body 522 and the second OIS magnetic body 532 may be disposed in the first carrier 330 such that one of an N pole and an S pole faces each of the first OIS coil 521 and the second OIS coil 531 disposed in the camera housing 320. In this case, as the first OIS actuator (e.g., the first OIS magnetic body 522 and the first OIS coil 521) moves the first carrier 330 in the X-axis direction of FIG. 4 with respect to the camera housing 320, the vertical distance (e.g., the X-axis direction distance of FIG. 4) between the first OIS magnetic body 522 and the first OIS coil 521 may change. In addition, as the second OIS actuator (e.g., the second OIS magnetic body 532 and the second OIS coil) moves the first carrier 330 in the Y-axis direction of FIG. 4 with respect to the camera housing 320, the vertical distance (e.g., the Y-axis direction distance of FIG. 4) between the first OIS magnetic body 522 and the first OIS coil 521 may change.

According to an embodiment, as illustrated in FIG. 4, at least one AF ball b1 may be disposed between the second carrier 340 and the camera housing 320. In an embodiment, the AF ball b1 may be a bearing ball. In an embodiment, the AF ball b1 may guide the movement of the second carrier 340 when the second carrier 340 moves with respect to the camera housing 320 through an electromagnetic force between the AF magnetic body 512 and the AF coil 511. For example, the AF ball b1 may guide the movement of the second carrier 340 in the optical axis direction with respect to the camera housing 320.

In an embodiment, referring to FIG. 4, the AF ball b1 may be disposed in first guide grooves 4011 and 4012 and second guide grooves 4021 and 4022 that extend substantially in the optical axis direction (e.g., the Z-axis direction of FIG. 4) in at least one of the camera housing 320 and the second carrier 340. In an embodiment, the first guide grooves 4011 and 4012 may be provided in the first portion 3221 of the camera housing 320. In an embodiment, the second guide grooves 4021 and 4022 may be provided in the second carrier 340 to correspond to the first guide grooves 4011 and 4012. In an embodiment, referring to FIG. 4, the first guide grooves 4011 and 4012 may include a (1-1)^{th} guide groove 4011 and a (1-2)th guide groove 4012. In an embodiment, the (1-1)^{th} guide groove 4011 and the (1-2)^{th} guide groove 4012 may be spaced apart from each other in the first portion 3221 of the camera housing 320. In an embodiment, the AF coil 511 may be disposed between the (1-1)^{th} guide groove 4011 and the (1-2)^{th} guide groove 4012. In an embodiment, referring to FIG. 4, the second guide grooves 4021 and 4022 may include a (2-1)^{th} guide groove 4021 and a (2-2)^{th} guide groove 4022. In an embodiment, the (2-1)th guide groove 4021 may be provided in the second carrier 340 to correspond to the (1-1)th guide groove 4011. The (2-2)^{th} guide groove 4022 may be provided in the second carrier 340 to correspond to the (1-2)^{th} guide groove 4012. In an embodiment, the AF magnetic body 512 may be disposed between the (2-1)h guide groove 4021 and the (2-2)^{th} guide groove 4022. In an embodiment, the AF balls b1 may be disposed between the (1-1)^{th} guide groove 4011 and the (2-1)^{th} guide groove 4021 and between the (1-2)^{th} guide groove 4012 and the (2-2)^{th} guide groove 4022, respectively, to guide the movement of the second carrier 340 in the optical axis direction with respect to the camera housing 320.

According to an embodiment, as illustrated in FIG. 4, one or more OIS balls b2 may be disposed between the first carrier 330 and the second carrier 340. In an embodiment, the OIS balls b2 may be bearing balls. In an embodiment, the OIS balls b2 may guide the movement of the first carrier 330 in the first axis direction and/or the second axis direction when the first carrier 330 moves with respect to the second carrier 340 through the electromagnetic force of the first OIS actuator and/or the second OIS actuator.

In an embodiment, there may be three or more OIS balls b2, and may be disposed at positions corresponding to the four corners of the substantially rectangular first carrier 330. In an embodiment, when a middle guide 350 (e.g., the middle guide 350) is not disposed between the first carrier 330 and the second carrier 340, the OIS balls b2 may be disposed in guide grooves respectively provided on surfaces where the first carrier 330 and the second carrier 340 face each other. In an embodiment, when the middle guide 350 is disposed between the first carrier 330 and the second carrier 340, the first carrier 330 may include third guide grooves 403 provided on its surface facing the middle guide 350 (e.g., the surface oriented in the −Z direction of FIG. 4). The middle guide 350 may include fourth guide grooves 404 provided on its surface facing the first carrier 330 (e.g., the surface oriented in the +Z direction of FIG. 4) and corresponding to the third guide grooves 403. In an embodiment, the OIS balls b2 may be accommodated in the third guide grooves 403 and the fourth guide grooves 404 to guide the movement of the first carrier 330 with respect to the second carrier 340. In an embodiment, the third guide grooves 403 and the fourth guide grooves 404 may each include a groove that guides the movement of an OIS ball b2 in the X-axis direction and a groove that guides the movement of an OIS ball b2 in the Y-axis direction. In an embodiment, the fourth guide grooves 404 may be provided on different surfaces of the middle guide 350.

According to an embodiment, as illustrated in FIGS. 4 and 6, an IR filter 400 and an image sensor 391 may be disposed in the side wall portion 322 (e.g., the fourth portion 3224) of the camera housing 320. In an embodiment, the image sensor 391 may be disposed in the fourth portion 3224 of the camera housing 320 so as to face the IR filter 400. In an embodiment, the IR filter 400 may be a filter that selectively reflects or absorbs near-infrared wavelengths to block their inflow into the image sensor 391. In an embodiment, the IR filter 400 may be disposed in the fourth portion 3224 of the camera housing 320 so as to be positioned between the exit surface S2 of the reflective member R and the image sensor 391. The image sensor 391 may detect light emitted or reflected from a subject and transmitted through the lens 361, the reflective member R, and the IR filter 400, and may convert the light into an electrical signal to acquire an image corresponding to the subject. In an embodiment, a board (e.g., a flexible printed circuit board) 390 connected to the image sensor 391 may be electrically connected to a main board where the processor 120 is disposed through a connector 392.

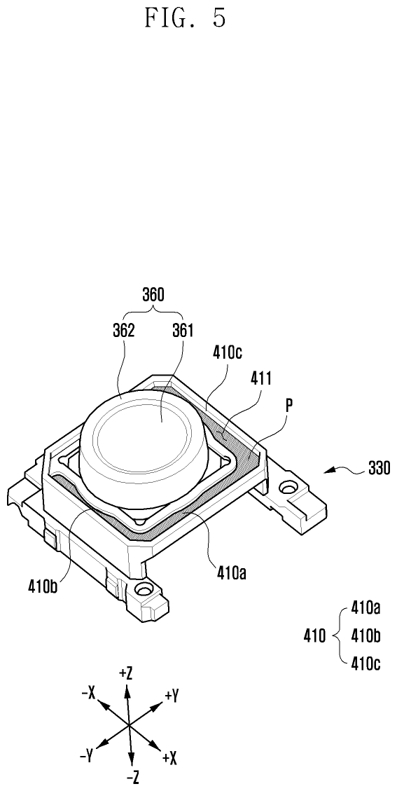

FIG. 5 is a perspective view of a first carrier including a foreign substance trapping portion according to various embodiments. FIG. 6 is a cross-sectional view taken along P1-P1 of FIG. 3B according to various embodiments.

According to an embodiment, the cover member 380 may include an opening 383 configured to accommodate the lens assembly 360. At least a portion of the lens assembly 360 may be accommodated in the opening 383 of the cover member 380. In an embodiment, the lens assembly 360 may be disposed in the first carrier 330 to move in the first axis direction and/or the second axis direction with respect to the second carrier 340 together with the first carrier 330 for image stabilization. The opening 383 of the cover member 380 may be have a size capable of accommodating the movement of the lens assembly 360. In an embodiment, foreign substances inside the electronic device 101 and/or foreign substances outside the electronic device 101 may be introduced into the camera module 300 through the opening 383 of the cover member 380. Foreign substances introduced into the camera module 300 may be introduced into the image sensor 391 or a component adjacent to the image sensor 391 (e.g., the IR filter 400). In this case, when capturing a photo or video, the foreign substances may be captured together, thereby degrading the quality of the photo or video. According to an embodiment of the disclosure, the camera module 300 may include a foreign substance trapping portion 410 (e.g., a trap, a dust trap, a foreign substance blocking portion, and/or an adsorption portion) disposed inside. In an embodiment, the foreign substance trapping portion 410 may be positioned in a path where foreign substances introduced into the camera module 300 (e.g., foreign substances introduced through the opening 383 of the cover member 380 or foreign substances existing inside the camera module 300) are introduced into the image sensor 391. For example, when the camera module 300 is viewed from above (e.g., when viewed in the −Z direction of FIG. 6), at least a portion of the foreign substance trapping portion 410 may be disposed between the lens assembly 360 and the image sensor 391. In an embodiment, the foreign substance trapping portion 410 may include an adhesive member P (e.g., a bond, a double-sided tape, or a liquid adhesive) capable of trapping foreign substances. Accordingly, foreign substances introduced into the camera module 300 may be adsorbed onto the adhesive member P of the foreign substance trapping portion 410, thereby reducing or preventing the introduction of foreign substances into the vicinity of the image sensor 391.

In an embodiment, the foreign substance trapping portion 410 may be provided in at least one of the lens barrel 362 of the lens assembly 360, the first carrier 330 configured to accommodate the lens assembly 360, and the bracket 310 configured to accommodate the reflective member R. For example, the foreign substance trapping portion 410 may be a portion of the lens barrel 362, the first carrier 330, and/or the bracket 310. In an embodiment, the foreign substance trapping portion 410 may be disposed such that at least a portion thereof protrudes toward the image sensor 391 from at least one of the lens barrel 362, the first carrier 330, and the bracket 310, and when the camera module 300 is viewed from above (e.g., in the −Z direction of FIG. 6), the foreign substance trapping portion may be at least partially disposed between the lens 361 and the image sensor 391.

In an embodiment, the foreign substance trapping portion 410 may include a recess 411 where the adhesive member P is disposed. The foreign substance trapping portion 410 may be disposed inside the recess 411 to trap foreign substances introduced into the camera module 300 (e.g., foreign substances introduced through the opening 383 of the cover member 380 or foreign substances that were already present inside the camera module 300). In various embodiments, the foreign substance trapping portion 410 may not include the recess 411. For example, in an embodiment where the adhesive member P is a double-sided tape, the adhesive member P may be attached to a surface of the foreign substance trapping portion 410.

In an embodiment, the adhesive member P of the foreign substance trapping portion 410 may be in a liquid state and may be applied to the recess 411 of the foreign substance trapping portion 410 using a dispenser or an injector. In an embodiment, the liquid adhesive member P may include at least one of epoxy resin, silicone, acrylic, polyurethane, and cyanoacrylate. In an embodiment, the adhesive member P may be a double-sided tape.

According to an embodiment, the examples of FIGS. 5, 6, and 7 to be described in greater detail below may correspond to an embodiment in which the foreign substance trapping portion 410 is provided in the first carrier 330. In an embodiment, referring to FIGS. 5 and 6, the first carrier 330 may include the foreign substance trapping portion 410. In an embodiment, at least a portion of the foreign substance trapping portion 410 may protrude from the first carrier 330 toward the image sensor 391 in the +X direction of FIG. 6. In an embodiment, when the cover member 380 is viewed from above, the foreign substance trapping portion 410 may be provided outside the receiving groove 331 where the lens assembly 360 is disposed, and may be at least partially disposed between the lens assembly 360 and the image sensor 391. For example, the recess 411 and the adhesive member P of the foreign substance trapping portion 410 may be disposed between the lens assembly 360 and the image sensor 391. In an embodiment, when the cover member 380 is viewed from above, at least a portion of the foreign substance trapping portion 410 may be disposed between the exit surface S2 of the reflective member R and the image sensor 391. In this case, when the cover member 380 is viewed from above, the recess 411 and the adhesive member P of the foreign substance trapping portion 410 may be at least partially disposed between the exit surface S2 of the reflective member R and the image sensor 391. Accordingly, foreign substances introduced into the camera module 300 may be adsorbed onto the foreign substance trapping portion 410 and may not be introduced into the vicinity of the image sensor 391.

In an embodiment, referring to FIGS. 5 and 6, when the cover member 380 is viewed from above (e.g., in the −Z direction of FIG. 6), the foreign substance trapping portion 410 may be disposed to at least partially surround the lens assembly 360. In an embodiment, when the cover member 380 is viewed from above (e.g., in the −Z direction of FIG. 6), the foreign substance trapping portion 410 may include a first portion 410a positioned between the lens assembly 360 and the image sensor 391, a second portion 410b extending along the X-axis of FIG. 5 perpendicular to the first portion 410a, and a third portion 410c extending along the X-axis of FIG. 5 perpendicular to the first portion 410a and facing the second portion 410b. In an embodiment, as illustrated in FIGS. 5 and 6, as the foreign substance trapping portion 410 includes the first portion 410a, the second portion 410b, and the third portion 410c, the area corresponding to the opening 383 of the cover member 380 may increase. As the area of the foreign substance trapping portion 410 corresponding to the opening 383 of the cover member 380 increases, the amount of foreign substances to be trapped may increase.

In the above description, the foreign substance trapping portion 410 provided in the first carrier 330 has been described as including the first portion 410a, the second portion 410b, and the third portion 410c, but may not be necessarily limited thereto. For example, one of the second portion 410b and the third portion 410c of the foreign substance trapping portion 410 may be omitted. In an embodiment, foreign substances introduced into the camera module 300 may be introduced into the image sensor 391 through a path between the lens assembly 360 and the image sensor 391. By disposing the foreign substance trapping portion 410 in the path between the lens assembly 360 and the image sensor 391, the amount of foreign substances introduced into the image sensor 391 may be reduced. Accordingly, even when including only the first portion 410a provided in the first carrier 330, the foreign substance trapping portion 410 may trap foreign substances introduced into the camera module 300 and reduce the amount of foreign substances introduced into the vicinity of the image sensor 391.

According to an embodiment, the positional relationship between the foreign substance trapping portion 410 and the opening 383 of the cover member 380 may vary. In an embodiment, referring to FIG. 6, when the cover member 380 is viewed from above (e.g., in the −Z direction of FIG. 6), the foreign substance trapping portion 410 may at least partially overlap the opening 383 of the cover member 380. For example, when the cover member 380 is viewed from above (e.g., in the −Z direction of FIG. 6), the recess 411 and the adhesive member P of the foreign substance trapping portion 410 may at least partially overlap the opening 383 of the cover member 380. In various embodiments, the recess 411 and the adhesive member P of the foreign substance trapping portion 410 may be positioned outside the opening 383 of the cover member 380 when viewed from above and may not overlap the opening 383 of the cover member 380. In an embodiment, the maximum radius of the recess 411 and the adhesive member P centered on the optical axis of the lens 361 may be greater than the maximum radius of the opening 383 of the cover member 380. However, when the recess 411 of the foreign substance trapping portion 410 is positioned inside the opening 383 of the cover member 380 when the cover member 380 is viewed from above, the maximum radius of the recess 411 centered on the optical axis of the lens 361 may be equal to or smaller than the maximum radius of the opening 383 of the cover member 380. In addition, the positional relationship between the recess 411 and the adhesive member P of the foreign substance trapping portion 410 and the opening 383 of the cover member 380 may vary depending on the structure of the camera module 300.

According to an embodiment, as illustrated in FIG. 6, the lens assembly 360 may be inserted into the receiving groove 331 of the first carrier 330 and fixed to the first carrier 330 using an adhesive (e.g., a bond or tape). In an embodiment, the adhesive member P disposed in the recess 411 of the foreign substance trapping portion 410 may extend into the receiving groove 331 of the first carrier 330 to cover the adhesive that attaches the lens assembly 360 to the first carrier 330. Accordingly, as the area where the adhesive member P is disposed expands, the foreign substance trapping portion 410 may improve its ability to trap foreign substances introduced into the camera module 300.

In an embodiment, referring to FIG. 6, at least a portion of the receiving groove 331 of the first carrier 330 may be located below the recess 411 of the foreign substance trapping portion 410 (e.g., in the −Z direction of FIG. 6). For example, the receiving groove 331 of the first carrier 330 may include a first support surface 332 that supports or faces a protrusion 363 of the lens barrel 362. The first support surface 332 may be located below (e.g., in the −Z direction of FIG. 6) a second support surface 412 located in the recess 411. Accordingly, the adhesive member P disposed in the recess 411 of the foreign substance trapping portion 410 may extend into the receiving groove 331 of the first carrier 330 to cover the adhesive that attaches the lens assembly 360 to the first carrier 330.

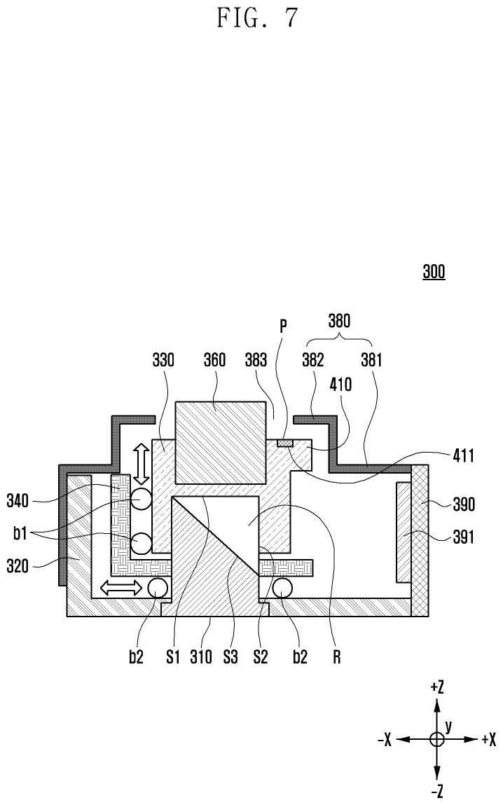

FIG. 7 is a cross-sectional view illustrating an example in which the first carrier is movable in an optical axis direction with respect to a second carrier, and the second carrier is movable in a direction perpendicular to the optical axis with respect to the camera housing according to various embodiments.

According to an embodiment, FIG. 7 is based on the premise that the first carrier 330 of the camera module 300 described with reference to FIGS. 3A, 3B, 4, 5 and 6 (which may be referred to as FIGS. 3A to 6) is an AF driver and the second carrier 340 is an OIS driver. In the following description, explanations of configurations that are the same as or similar to those of the camera module 300 described with reference to FIGS. 3A to 6 may not be repeated here.

In an embodiment, referring to FIG. 7, the first carrier 330 may be an AF driver disposed in the second carrier 340. In an embodiment, as the processor 120 controls an AF actuator (e.g., an AF coil (not illustrated) (e.g., the AF coil 511 in FIG. 4) and an AF magnetic body (not illustrated) (e.g., the AF magnetic body 512 in FIG. 4)), the first carrier 330 may perform an AF function of automatically adjusting the focus of the lens 361 on a subject by moving in the optical axis direction of the lens 361 (e.g., in the Z-axis direction of FIG. 7) with respect to the camera housing 320.

In an embodiment, as the processor 120 controls an OIS actuator (e.g., the OIS coils 521 and 531 and the OIS magnetic body 522 of 532 in FIG. 4), the second carrier 340 may move in a first axis direction perpendicular to the optical axis of the lens 361 (e.g., in the X-axis or Y-axis direction of FIG. 7) and/or in a second axis direction (e.g., in the Y-axis or X-axis direction of FIG. 7) with respect to the camera housing 320, thereby performing image stabilization.

In an embodiment, since the first carrier 330 serves as the AF driver, the AF actuator may include an AF coil disposed in the second carrier 340 and an AF magnetic body disposed in the first carrier 330 to face the AF coil. In various embodiments, the AF coil may be disposed in the first carrier 330, and the AF magnetic body may be disposed in the second carrier 340. The first carrier 330 may perform the AF function of automatically adjusting the focus of the lens 361 on a subject by moving in the optical axis direction through the electromagnetic force acting between the AF coil and the AF magnetic body. In an embodiment, the AF balls b1 may be disposed between the first carrier 330 and the second carrier 340 to guide the movement of the first carrier 330 in the optical axis direction with respect to the second carrier 340.

In an embodiment, since the second carrier 340 serves as the OIS driver, the first OIS actuator may include a first OIS coil (e.g., the first OIS coil 521 in FIG. 4) disposed in a portion of the camera housing 320 and a first OIS magnetic body (not illustrated) (e.g., the first OIS magnetic body 522 in FIG. 4) disposed in the second carrier 340 to face the first OIS coil. In various embodiments, the first OIS coil may be disposed in the second carrier 340, and the first OIS magnetic body may be disposed in the camera housing 320. In an embodiment, the second carrier 340 may move in the first axis direction substantially perpendicular to the optical axis through the electromagnetic force acting between the first OIS coil and the first OIS magnetic body, thereby performing image stabilization. In an embodiment, the second OIS actuator may include a second OIS coil (not illustrated) (e.g., the second OIS coil 531 in FIG. 4) disposed in a portion of the camera housing 320 and a second OIS magnetic body (not illustrated) (e.g., the second OIS magnetic body 532 in FIG. 4) disposed in the second carrier 340 to face the second OIS coil. In various embodiments, the second OIS coil may be disposed in the second carrier 340, and the second OIS magnetic body may be disposed in the camera housing 320. In an embodiment, the second carrier 340 may move in the second axis direction substantially perpendicular to the optical axis through the electromagnetic force acting between the second OIS coil and the second OIS magnetic body, thereby performing image stabilization. In an embodiment, the OIS balls b2 may be disposed between the second carrier 340 and the camera housing 320 to guide the movement of the second carrier 340 in the first axis direction and/or the second axis direction with respect to the camera housing 320.

In an embodiment, the foreign substance trapping portion 410 of FIG. 7 may be substantially the same as the foreign substance trapping portion 410 of FIG. 5 except that the foreign substance trapping portion 410 is provided in the first carrier 330, which serves as the AF driver. In an embodiment, the foreign substance trapping portion 410 (e.g., the foreign substance trapping portion 410 in FIG. 5) may be provided in the first carrier 330, which serves as the AF driver. In an embodiment, the foreign substance trapping portion 410 may be positioned in a path where foreign substances introduced into the camera module 300 (e.g., foreign substances introduced through the opening 383 of the cover member 380 or foreign substances existing inside the camera module 300) are introduced into the image sensor 391. For example, when the camera module 300 is viewed from above (e.g., in the −Z direction of FIG. 7), at least a portion of the foreign substance trapping portion 410 may be disposed between the lens assembly 360 and the image sensor 391. Accordingly, foreign substances introduced into the camera module 300 may be adsorbed by the adhesive member P of the foreign substance trapping portion 410 and may not be introduced into the vicinity of the image sensor 391.

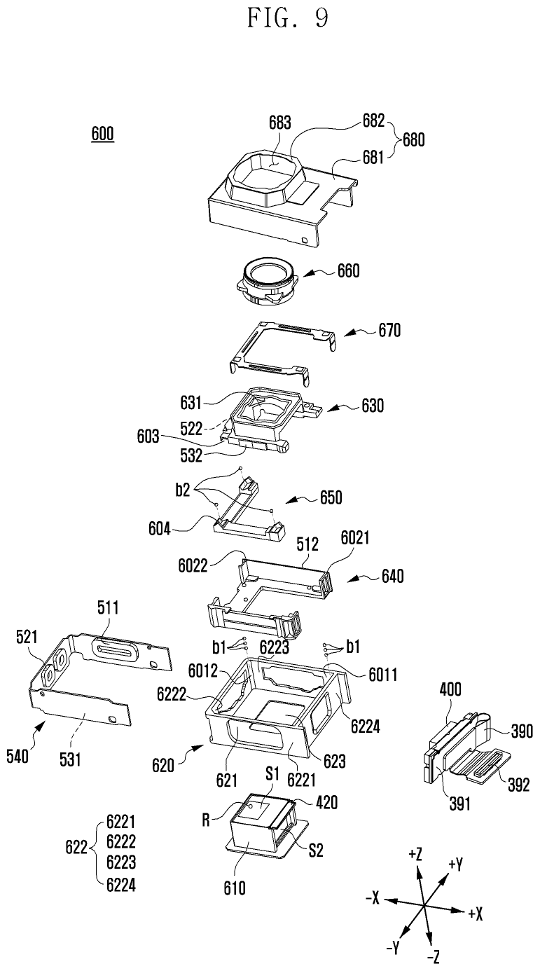

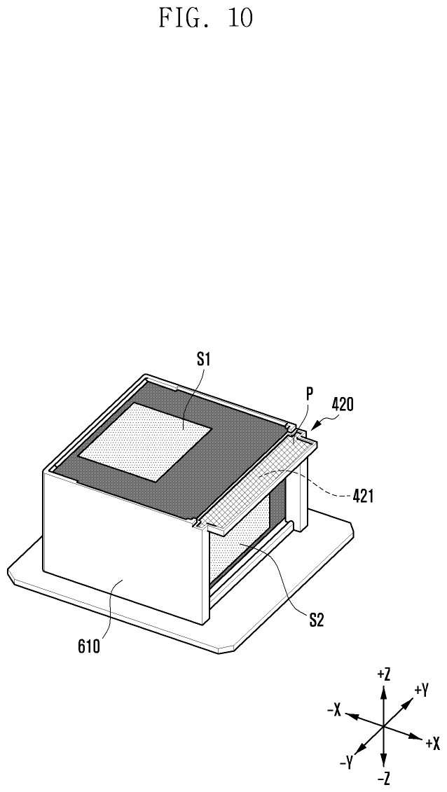

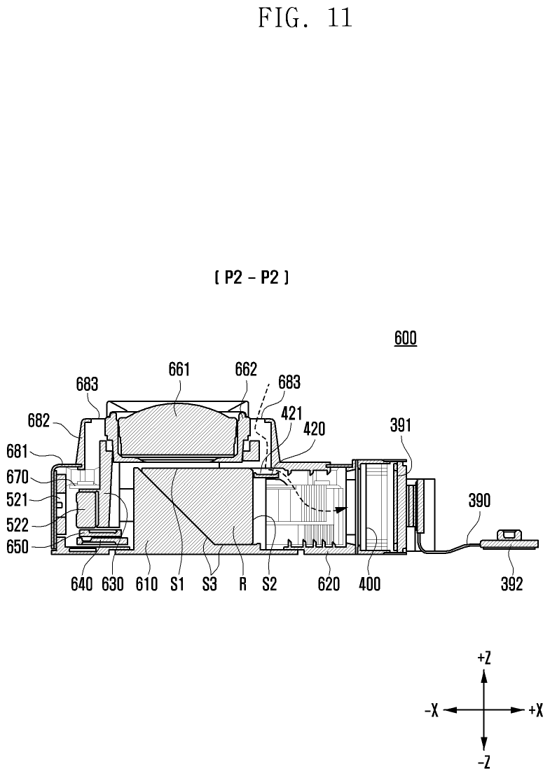

FIG. 8 is a perspective view of a camera module according to various embodiments. FIG. 9 is an exploded perspective view of the camera module illustrated in FIG. 8 according to various embodiments. FIG. 10 is a perspective view of a bracket where a reflective member is disposed and which includes a foreign substance trapping portion according to various embodiments. FIG. 11 is a cross-sectional view taken along P2-P2 of FIG. 8 according to various embodiments.

The example illustrated in FIGS. 8, 9, 10 and 11 (which may be referred to as FIGS. 8 to 11) may illustrate an example in which the foreign substance trapping portion 420 is provided in the bracket 610 (e.g., the bracket 310 of FIG. 4). In the following description, explanations of configurations that are the same as or similar to those described with reference to FIGS. 3A to 7 may not be repeated here. The example of FIGS. 8 to 11 may differ from that of FIGS. 3A to 7 in terms of the cover member 680 (e.g., the cover member 380 in FIG. 4) and the bracket 610. Accordingly, differences between the cover member 380 and the bracket 310 of FIG. 4 and the cover member 680 and the bracket 610 of FIG. 9 will be described.

According to an embodiment of the disclosure, as illustrated in FIGS. 8 and 9, the camera module 600 (e.g., the camera module 180 in FIG. 1, or the camera module 300 in FIG. 3A) may include a bracket 610 (e.g., the bracket 310 of FIG. 4) configured to accommodate a reflective member R, a camera housing 620 (e.g., the camera housing 320 in FIG. 4), a first carrier 630 (e.g., the first carrier 330 in FIG. 4, a first housing, a first bracket, or an OIS carrier) including a receiving groove 631, a second carrier 640 (e.g., the second carrier 340 in FIG. 4, a second housing, a second bracket, or an AF carrier), a middle guide 650 (e.g., the middle guide 350 in FIG. 4, or a guide member), a lens assembly 660 (e.g., the lens assembly 360 in FIG. 4) including a lens 661 (e.g., the lens 661 in FIG. 11 or the lens 361 of FIG. 4) and a lens barrel 662 (e.g., the lens barrel 662 in FIG. 11 or the lens barrel 362 in FIG. 4), a stopper 670 (e.g., the stopper 370 in FIG. 4), a cover member 680 (e.g., the cover member 380 in FIG. 4 or a shield can), an image sensor 391 (e.g., the image sensor 391 in FIG. 4), an IR filter 400 (e.g., the IR filter 400 in FIG. 4), an AF actuator (e.g., an AF magnetic body 512 (e.g., the magnetic body 512 in FIG. 4) and an AF coil 511 (e.g., the AF coil 511 in FIG. 4)), a first OIS actuator (e.g., a first OIS magnetic body 522 (e.g., the first OIS magnetic body 522 in FIG. 4) and a first OIS coil 521 (e.g., the first OIS coil 521 in FIG. 4)), a second OIS actuator (e.g., a second OIS magnetic body 532 (e.g., the second OIS magnetic body 532 in FIG. 4) and a second OIS coil 531 (e.g., the second OIS coil 531 in FIG. 4)), a flexible printed circuit board (FPCB) 540 (e.g., the FPCB 540 of FIG. 4), and a plurality of AF balls b1 (e.g., the AF balls b1 of FIG. 4) and/or a plurality of OIS balls b2 (e.g., the OIS ball b2 of FIG. 4). At least one of the above-described components may be omitted, or other components may be added. In an embodiment, like the camera housing 320 of FIG. 4, the camera housing 620 may include an opening 623 into which the bracket 610 is inserted, a support portion 621, and a side wall portion 622 (e.g., a first portion 6221, a second portion 6222, a third portion 6223, and a fourth portion 6224). In an embodiment, the AF coil 511 may be disposed in the third portion 6223 of the camera housing 620, the first OIS coil 521 may be disposed in the second portion 6222, the second OIS coil 531 may be disposed in the first portion 6221, and the image sensor 391 may be disposed in the fourth portion 6224.

In an embodiment, referring to FIG. 9, the AF ball b1 may be disposed in first guide grooves 6011 and 6012 and second guide grooves 6021 and 6022 that extend substantially in the optical axis direction (e.g., the Z-axis direction of FIG. 9) in at least one of the camera housing 620 and the second carrier 640. In an embodiment, the first guide grooves 6011 and 6012 may be provided in the third portion 6223 of the camera housing 620. In an embodiment, the second guide grooves 6021 and 6022 may be provided in the second carrier 640 to correspond to the first guide grooves 6011 and 6012. In an embodiment, referring to FIG. 9, the first guide grooves 6011 and 6012 may include a (1-1)^{th} guide groove 6011 and a (1-2)th guide groove 6012. In an embodiment, the (1-1)th guide groove 6011 and the (1-2)^{th} guide groove 6012 may be spaced apart from each other in the third portion 6223 of the camera housing 620. In an embodiment, the AF coil 511 may be disposed between the (1-1)^{th} guide groove 6011 and the (1-2)^{th} guide groove 6012. In an embodiment, referring to FIG. 9, the second guide grooves 6021 and 6022 may include a (2-1)^{th} guide groove 6021 and a (2-2)^{th} guide groove 6022. In an embodiment, the (2-1)th guide groove 6021 may be provided in the second carrier 640 to correspond to the (1-1)th guide groove 6011. The (2-2)^{th} guide groove 6022 may be provided in the second carrier 640 to correspond to the (1-2)^{th} guide groove 6012. In an embodiment, the AF magnetic body 512 may be disposed between the (2-1)h guide groove 6021 and the (2-2)^{th} guide groove 6022. In an embodiment, the AF balls b1 may be disposed between the (1-1)^{th} guide groove 6011 and the (2-1)^{th} guide groove 6021 and between the (1-2)^{th} guide groove 6012 and the (2-2)^{th} guide groove 6022, respectively, to guide the movement of the second carrier 640 in the optical axis direction with respect to the camera housing 620.

In an embodiment, referring to FIG. 9, there may be three or more OIS balls b2, and may be disposed at positions corresponding to the four corners of the substantially rectangular first carrier 630. In an embodiment, when a middle guide 650 (e.g., the middle guide 650) is not disposed between the first carrier 630 and the second carrier 640, the OIS balls b2 may be disposed in guide grooves respectively provided on surfaces where the first carrier 630 and the second carrier 640 face each other. In an embodiment, when the middle guide 650 is disposed between the first carrier 630 and the second carrier 640, the first carrier 630 may include third guide grooves 603 provided on its surface facing the middle guide 650 (e.g., the surface oriented in the −Z direction of FIG. 9). The middle guide 650 may include fourth guide grooves 604 provided on its surface facing the first carrier 630 (e.g., the surface oriented in the +Z direction of FIG. 9) and corresponding to the third guide grooves 603. In an embodiment, the OIS balls b2 may be accommodated in the third guide grooves 603 and the fourth guide grooves 604 to guide the movement of the first carrier 630 with respect to the second carrier 640. In an embodiment, the third guide grooves 603 and the fourth guide grooves 604 may each include a groove that guides the movement of an OIS ball b2 in the X-axis direction and a groove that guides the movement of an OIS ball b2 in the Y-axis direction. In an embodiment, the fourth guide grooves 604 may be provided on different surfaces of the middle guide 650.

According to an embodiment, as illustrated in FIGS. 8 and 9, the cover member 680 may have a two-step shape. In an embodiment, the cover member 680 may include a first cover portion 681 coupled to the camera housing 620 and a second cover portion 682 protruding from the first cover portion 681. In an embodiment, the cover member 680 may be formed such that after the first cover portion 681 is formed, the second cover portion 682 is formed on the first cover portion 681 through a separate insert injection molding process. In an embodiment, the insert injection molding process may be a process in which a pre-manufactured component is pre-placed in an injection mold, and then an injection material is injected into the mold to form a final product. In an embodiment, the cover member 680 may be formed as the first cover portion 681 is placed in the injection mold, and then an injection material forming the second cover portion 682 is injected into the mold. In an embodiment, the first cover portion 681 and the second cover portion 682 may be formed in various shapes as they are manufactured through different injection molding processes. In addition, since the first cover portion 681 and the second cover portion 682 are formed through different injection molding processes, they may be formed of different materials or the same material.

According to an embodiment, as illustrated in FIGS. 9, 10, and 11, the bracket 610 configured to accommodate the reflective member R may include a foreign substance trapping portion 420. In an embodiment, at least a portion of the foreign substance trapping portion 420 may protrude from the bracket 610 toward the image sensor 391 in the +X direction of FIG. 11. In an embodiment, the foreign substance trapping portion 420 may be disposed in the bracket 610 substantially parallel to the incident surface S1 of the reflective member R.

In an embodiment, referring to FIGS. 9, 10, and 11, when the cover member 680 is viewed from above, the foreign substance trapping portion 420 may be disposed between the lens assembly 660 and the image sensor 391. For example, the recess 421 and the adhesive member P of the foreign substance trapping portion 420 may be disposed between the lens assembly 660 and the image sensor 391. In an embodiment, when the cover member 680 is viewed from above, at least a portion of the foreign substance trapping portion 420 may be disposed between the exit surface S2 of the reflective member R and the image sensor 391. In this case, when the cover member 680 is viewed from above, the recess 421 and the adhesive member P of the foreign substance trapping portion 420 may be at least partially disposed between the exit surface S2 of the reflective member R and the image sensor 391. Accordingly, foreign substances introduced into the camera module 600 may be adsorbed onto the foreign substance trapping portion 420 and may not be introduced into the vicinity of the image sensor 391.

In an embodiment not illustrated in the drawings, when the cover member 680 is viewed from above (e.g., in the −Z direction of FIG. 11), the foreign substance trapping portion 420 may be provided in the bracket 610 so as to surround at least a portion of the lens assembly 660, like the foreign substance trapping portion 420 of FIG. 5. In an embodiment, when the cover member 680 is viewed from above (e.g., in the −Z direction of FIG. 11), the foreign substance trapping portion 420 may include a first portion positioned between the lens assembly 660 and the image sensor 391, a second portion extending perpendicular to the first portion, and a third portion extending perpendicular to the first portion and facing the second portion. In an embodiment, as the foreign substance trapping portion 420 includes the first portion, the second portion, and the third portion, the area corresponding to the opening 683 of the cover member 680 may be increased. As the area of the foreign substance trapping portion 420 corresponding to the opening 683 of the cover member 680 increases, the amount of foreign substances to be trapped may increase.

According to an embodiment, the positional relationship between the foreign substance trapping portion 420 and the opening 683 of the cover member 680 may vary. In an embodiment, referring to FIG. 11, when the cover member 680 is viewed from above (e.g., in the −Z direction of FIG. 11), the foreign substance trapping portion 420 may at least partially overlap the opening 683 of the cover member 680. For example, when the cover member 680 is viewed from above (e.g., in the −Z direction of FIG. 11), the recess 421 and the adhesive member P of the foreign substance trapping portion 420 may at least partially overlap the opening 683 of the cover member 680. In various embodiments, the recess 421 and the adhesive member P of the foreign substance trapping portion 420 may be positioned outside the opening 683 of the cover member 680 when viewed from above and may not overlap the opening 683 of the cover member 680.

In an embodiment, the maximum radius of the recess 421 and the adhesive member P centered on the optical axis of the lens 661 may be greater than the maximum radius of the opening 683 of the cover member 680. However, when the recess 421 of the foreign substance trapping portion 420 is positioned inside the opening 683 of the cover member 680 when the cover member 680 is viewed from above, the maximum radius of the recess 421 centered on the optical axis of the lens 661 may be equal to or smaller than the maximum radius of the opening 683 of the cover member 680. In addition, the positional relationship between the recess 421 and the adhesive member P of the foreign substance trapping portion 420 and the opening 683 of the cover member 680 may vary depending on the structure of the camera module 600.

In an embodiment of the disclosure, the camera module 600 may include the foreign substance trapping portion 420 provided in the bracket 610 and positioned between the lens assembly 660 and the image sensor 391. As illustrated in FIG. 11, the adhesive member P of the foreign substance trapping portion 420 may trap foreign substances introduced through the opening 683 of the cover member 680 or foreign substances present inside the camera module 600. As a result, by reducing the amount of foreign substances that is introduced into the camera module 600 and is then introduced into the vicinity of the image sensor 391, deterioration in image and video quality due to foreign substances may be suppressed or prevented.

The camera module (e.g., the camera module 180 in FIG. 1, the camera module 300 in FIG. 3A, and the camera module 600 in FIG. 8) may support high magnification by utilizing light refraction. The camera module 180, 300, or 600 using light refraction may include a camera housing 320 or 620, a reflective member R (e.g., a prism or a mirror), a lens assembly 360 or 660 including at least one lens 361 or 661, and an image sensor 230 or 391. The lens assembly 360 or 660 may be disposed in the camera housing 320 or 620 so as to face the incident surface S1 of the reflective member R through which light is introduced in the state in which the reflective member R is disposed inside the camera housing 320, 620. Light passing through the lens assembly 360 or 660 may be introduced into the incident surface S1 of the reflective member R, and after being reflected or refracted by the reflective member R, the light may be delivered to the image sensor 230 or 391.

The camera module 180, 300, or 600 may include a cover member (e.g., a shield can) 380 or 680 forming the exterior. The cover member 380 or 680 may include an opening 383 or 683 configured to accommodate the lens assembly 360 or 660 so that the lens 361 or 661 is visually exposed outside the camera module 180, 300, or 600. The lens assembly 360 or 660 may be disposed in a carrier (e.g., the first carrier 330 in FIG. 4 or the first carrier 630 in FIG. 9) disposed below the cover member 380 or 680, and may adjust the focus of the lens 361 or 661 by moving in the optical axis direction (e.g., the Z-axis direction of FIG. 3A or FIG. 8) of the lens 361 or 661 or may perform image stabilization by moving in a direction perpendicular to the optical axis (e.g., the X-axis and/or Y-axis direction of FIG. 3A or FIG. 8). The opening 383 or 683 of the cover member 380 or 680 may have a size capable of accommodating the movement of the lens assembly 360 or 660. Foreign substances inside and/or outside the electronic device 101 may be introduced into the camera module 180, 300, or 600 through the opening 383 or 683 of the cover member 380 or 680. Foreign substances introduced into the camera module 180, 300, or 600 may be introduced into the vicinity of the image sensor 230 or 391. In this case, when capturing a photo or video, the foreign substances may be captured together, thereby degrading the quality of the photo or video.

According to an example embodiment of the disclosure, a camera module may include a reflective member comprising a reflective surface including an incident surface and an exit surface configured to pass light introduced into the incident surface, a bracket where the reflective member is disposed, a camera housing including a support where at least a portion of the bracket is disposed, and a side wall perpendicular to the support, a first carrier disposed in the camera housing and at least partially facing the bracket, a lens assembly including at least one lens facing the incident surface of the reflective member and disposed in the first carrier such that the lens is spaced apart from the reflective member in a direction of an optical axis of the lens, a cover including an opening configured to accommodate a portion of the lens assembly, the cover being coupled to the camera housing, an image sensor disposed on the camera housing, and configured to receive light that has passed through the exit surface of the reflective member, a foreign substance trap, at least a portion of which is disposed between the image sensor and the lens assembly when the cover member is viewed from above, and an adhesive member comprising an adhesive material disposed on the foreign substance trap.

In an example embodiment, the foreign substance trap may be provided in one of the bracket, the first carrier, and the lens assembly.

In an example embodiment, when the cover is viewed from above, at least a portion of the foreign substance trap may overlap the opening.

In an example embodiment, the foreign substance trap may include a first portion positioned between the lens assembly and the image sensor when the cover member is viewed from above, a second portion extending perpendicular to the first portion, and a third portion extending perpendicular to the first portion and facing the second portion. The foreign substance trap may be provided in the first carrier.

In an example embodiment, the first carrier may include a receiving groove configured to accommodate the lens assembly, and the foreign substance trap may include a recess provided outside the receiving groove when the cover member is viewed from above, the adhesive member being disposed in the recess.

In an example embodiment, the adhesive member may extend from the recess to the receiving groove and may cover an adhesive that attaches the first carrier to the lens assembly.

In an example embodiment, a first support surface located inside the receiving groove of the first carrier may be located below a second support surface located inside the recess of the foreign substance trap.

In an example embodiment, the foreign substance trap may be provided in the bracket and protrudes toward the image sensor, and when the cover member is viewed from above, the foreign substance trap may be substantially parallel to the incident surface of the reflective member facing the lens assembly.

In an example embodiment, the foreign substance trap may include a recess where the adhesive member is disposed.

In an example embodiment, the cover may include a first cover portion coupled to the camera housing, and a second cover portion protruding from the first cover portion. The opening may be provided in the second cover portion.

In an example embodiment, the second cover portion may be insert injection molded on the first cover portion.

In an example embodiment, the camera module may further include a second carrier disposed in the camera housing and configured to accommodate the first carrier.

In an example embodiment, the camera module may further include a first optical image stabilization (OIS) magnetic body disposed in one of the camera housing and the first carrier, a first OIS coil disposed in a remaining one of the camera housing and the first carrier and facing the first OIS magnetic body, a second OIS magnetic body disposed in the one of the camera housing and the first carrier, a second OIS coil disposed in the remaining one of the camera housing and the first carrier and facing the second OIS magnetic body, and an OIS ball disposed between the first carrier and the second carrier and configured to guide movement of the first carrier with respect to the second carrier. The first carrier may be configured to move in a first axis direction perpendicular to an optical axis of the lens through an electromagnetic force acting between the first OIS magnetic body and the first OIS coil, and to move in a second axis direction perpendicular to the first axis through an electromagnetic force acting between the second OIS magnetic body and the second OIS coil.

In an example embodiment, the camera housing may further include an auto-focus (AF) magnetic body disposed in one of the camera housing and the second carrier, an AF coil disposed in a remaining one of the camera housing and the second carrier, and an ball disposed between the camera housing and the second carrier and configured to guide movement of the second carrier with respect to the camera housing. The second carrier may be configured to move in an optical axis direction of the lens through an electromagnetic force acting between the AF magnetic body and the AF coil.

In an example embodiment, the camera housing may further include an AF magnetic body disposed in one of the first carrier and the second carrier, an AF coil disposed in a remaining one of the first carrier and the second carrier and facing the AF magnetic body, a first OIS magnetic body disposed in one of the camera housing and the second carrier, a first OIS coil disposed in a remaining one of the camera housing and the second carrier and facing the first OIS magnetic body, a second OIS magnetic body disposed in the one of the camera housing and the second carrier, a second OIS coil disposed in the remaining one of the camera housing and the second carrier and facing the second OIS magnetic body, an AF ball disposed between the first carrier and the second carrier and configured to guide movement of the first carrier with respect to the second carrier, and an OIS ball disposed between the second carrier and the camera housing and configured to guide movement of the second carrier with respect to the camera housing. The first carrier may be configured to move in an optical axis direction of the lens through an electromagnetic force acting between the AF magnetic body and the AF coil. The second carrier may be configured to move in a first axis direction perpendicular to an optical axis of the lens through an electromagnetic force acting between the first OIS magnetic body and the first OIS coil, and to move in a second axis direction perpendicular to the first axis through an electromagnetic force acting between the second OIS magnetic body and the second OIS coil.

In an example embodiment, the reflective member may include an incident surface facing the lens assembly and an exit surface perpendicular to the incident surface and facing the image sensor. When the cover is viewed from above, the foreign substance trap may be at least partially disposed between the exit surface of the reflective member and the image sensor.

In an example embodiment, the cover may include a material configured to shield electromagnetic waves.

In an example embodiment, the camera module may further include an additional reflective member comprising a reflective surface disposed between the reflective member and the side wall portion of the camera housing. The additional reflective member may include an incident surface facing the exit surface of the reflective member, and an exit surface facing the image sensor. The image sensor may be disposed on the support of the camera housing or on a portion facing the support portion, and may face the exit surface of the additional reflective member.

According to an example embodiment of the disclosure, in an electronic device including a camera module the camera module may include: a reflective member comprising a reflective surface including an incident surface and an exit surface configured to pass light introduced into the incident surface, a bracket where the reflective member is disposed, a camera housing including a support where at least a portion of the bracket is disposed, and a side wall perpendicular to the support portion, a first carrier disposed in the camera housing and at least partially facing the bracket, a lens assembly including at least one lens facing the incident surface of the reflective member and disposed in the first carrier such that the lens is spaced apart from the reflective member in a direction of an optical axis of the lens, a cover member including an opening configured to accommodate a portion of the lens assembly, the cover being coupled to the camera housing, an image sensor disposed on the camera housing, and configured to receive light that has passed through the exit surface of the reflective member, a foreign substance trap, at least a portion of which is disposed between the image sensor and the lens assembly when the cover member is viewed from above, and an adhesive member comprising an adhesive disposed on the foreign substance trap.

In an example embodiment, the foreign substance trap may be provided in one of the bracket, the first carrier, and the lens assembly.

In an example embodiment, when the cover is viewed from above, at least a portion of the foreign substance trap may overlap the opening.

According to an example embodiment of the disclosure, the camera module may include a foreign substance trap disposed therein (e.g., a dust trap, a foreign substance blocking portion, and/or an adsorption portion). The foreign substance trapping trap may be positioned in a path through which foreign substances introduced into the camera module (e.g., foreign substances introduced through the opening 383 or 683 of the cover member 380 or 680 or foreign substances already present within the camera module 180, 300, or 600) are introduced into the image sensor. The foreign substance trap may include an adhesive member comprising an adhesive (e.g., a bond, a double-sided tape, or a liquid adhesive) capable of trapping foreign substances. Accordingly, foreign substances introduced into the camera module may be adsorbed by the adhesive member of the foreign substance trap and may not be introduced into the vicinity of the image sensor. As a result, by reducing the amount of foreign substances that are introduced into the camera module and are then introduced into the vicinity of the image sensor, deterioration in image and video quality due to foreign substances may be suppressed or prevented.

Advantageous effects obtainable from the disclosure may not be limited to the above-mentioned effects, and other effects which are not mentioned may be clearly understood from the following descriptions by those skilled in the art to which the disclosure pertains.

The electronic device according to various embodiments set forth herein may be one of various types of electronic devices. The electronic device may include, for example, a portable communication device (e.g., a smart phone), a computer device, a portable multimedia device, a portable medical device, a camera, a wearable device, a home appliance, or the like. The electronic device according to embodiments of the disclosure is not limited to those described above.

It should be appreciated that various embodiments of the disclosure and the terms used therein are not intended to limit the technological features set forth herein to particular embodiments and the disclosure includes various changes, equivalents, or alternatives for a corresponding embodiment. With regard to the description of the drawings, similar reference numerals may be used to designate similar or relevant elements. A singular form of a noun corresponding to an item may include one or more of the items, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one or all possible combinations of the items enumerated together in a corresponding one of the phrases. Such terms as “a first,” “a second,” “the first,” and “the second” may be used to simply distinguish a corresponding element from another, and does not limit the elements in other aspect (e.g., importance or order). If an element (e.g., a first element) is referred to, with or without the term “operatively” or “communicatively”, as “coupled with/to” or “connected with/to” another element (e.g., a second element), the element may be coupled/connected with/to the other element directly (e.g., wiredly), wirelessly, or via a third element.

As used in various embodiments of the disclosure, the term “module” may include a unit implemented in hardware, software, or firmware, or any combination thereof, and may be interchangeably used with other terms, for example, “logic,” “logic block,” “component,” or “circuit”. The “module” may be a single integrated component, or a minimum unit or part thereof, adapted to perform one or more functions. For example, according to an embodiment, the “module” may be implemented in the form of an application-specific integrated circuit (ASIC).

According to various embodiments, each element (e.g., a module or a program) of the above-described elements may include a single entity or multiple entities, and some of the multiple entities may be separately disposed in another element. According to various embodiments, one or more of the above-described elements or operations may be omitted, or one or more other elements or operations may be added. Alternatively or additionally, a plurality of elements (e.g., modules or programs) may be integrated into a single element. In such a case, according to various embodiments, the integrated element may still perform one or more functions of each of the plurality of elements in the same or similar manner as they are performed by a corresponding one of the plurality of elements before the integration. According to various embodiments, operations performed by the module, the program, or another element may be carried out sequentially, in parallel, repeatedly, or heuristically, or one or more of the operations may be executed in a different order or omitted, or one or more other operations may be added.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. A camera module comprising:
a reflective member comprising a reflective surface including an incident surface and an exit surface configured to pass light introduced into the incident surface;
a bracket where the reflective member is disposed;
a camera housing comprising a support where at least a portion of the bracket is disposed, and a side wall perpendicular to the support;
a first carrier disposed in the camera housing and at least partially facing the bracket;
a lens assembly comprising at least one lens facing the incident surface of the reflective member and disposed in the first carrier such that the lens is spaced apart from the reflective member in a direction of an optical axis of the lens;
a cover comprising an opening configured to accommodate a portion of the lens assembly, the cover being coupled to the camera housing;
an image sensor disposed on the camera housing, and configured to receive light that has passed through the exit surface of the reflective member;
a foreign substance trap, at least a portion of which is disposed between the image sensor and the lens assembly when the cover member is viewed from above; and
an adhesive member comprising an adhesive disposed on the foreign substance trap.

2. The camera module of claim 1, wherein the foreign substance trap is provided in one of the bracket, the first carrier, and the lens assembly.

3. The camera module of claim 1, wherein, when the cover member is viewed from above, at least a portion of the foreign substance trap overlaps the opening.

4. The camera module of claim 2, wherein the foreign substance trap comprises:
a first portion positioned between the lens assembly and the image sensor when the cover member is viewed from above;
a second portion extending perpendicular to the first portion; and
a third portion extending perpendicular to the first portion and facing the second portion, and
wherein the foreign substance trap is provided in the first carrier.

5. The camera module of claim 4, wherein the first carrier comprises a receiving groove configured to accommodate the lens assembly, and
wherein the foreign substance trap comprises a recess provided outside the receiving groove when the cover member is viewed from above, the adhesive member being disposed in the recess.

6. The camera module of claim 5, wherein the adhesive member extends from the recess to the receiving groove and covers an adhesive that attaches the first carrier to the lens assembly.

7. The camera module of claim 5, wherein a first support surface located inside the receiving groove of the first carrier is located below a second support surface located inside the recess of the foreign substance trapping portion.

8. The camera module of claim 2, wherein the foreign substance trap is provided in the bracket and protrudes toward the image sensor, and when the cover member is viewed from above, the foreign substance trap is substantially parallel to the incident surface of the reflective member facing the lens assembly.

9. The camera module of claim 8, wherein the foreign substance trap comprises a recess where the adhesive member is disposed.

10. The camera module of claim 1, wherein the cover comprises a first cover portion coupled to the camera housing, and a second cover portion protruding from the first cover portion, the opening being provided in the second cover portion.

11. The camera module of claim 10, wherein the second cover portion is inser injection molded on the first cover portion.

12. The camera module of claim 1, further comprising:
a second carrier disposed in the camera housing and configured to accommodate the first carrier.

13. The camera module of claim 12, further comprising:
a first optical image stabilization (OIS) magnetic body disposed in one of the camera housing and the first carrier;
a first OIS coil disposed in a remaining one of the camera housing and the first carrier and facing the first OIS magnetic body;
a second OIS magnetic body disposed in the one of the camera housing and the first carrier;
a second OIS coil disposed in the remaining one of the camera housing and the first carrier and facing the second OIS magnetic body; and
an OIS ball disposed between the first carrier and the second carrier and configured to guide movement of the first carrier with respect to the second carrier,
wherein the first carrier is configured to:
move in a first axis direction perpendicular to an optical axis of the lens through an electromagnetic force acting between the first OIS magnetic body and the first OIS coil; and
move in a second axis direction perpendicular to the first axis through an electromagnetic force acting between the second OIS magnetic body and the second OIS coil.

14. The camera module of claim 13, further comprising:
an auto-focus (AF) magnetic body disposed in one of the camera housing and the second carrier;
an AF coil disposed in a remaining one of the camera housing and the second carrier; and
an AF ball disposed between the camera housing and the second carrier and configured to guide movement of the second carrier with respect to the camera housing,
wherein the second carrier is configured to move in an optical axis direction of the lens through an electromagnetic force acting between the AF magnetic body and the AF coil.

15. The camera module of claim 12, further comprising:
an auto-focus (AF) magnetic body disposed in one of the first carrier and the second carrier;
an AF coil disposed in a remaining one of the first carrier and the second carrier and facing the AF magnetic body;
a first optical image stabilization (OIS) magnetic body disposed in one of the camera housing and the second carrier;
a first OIS coil disposed in a remaining one of the camera housing and the second carrier and facing the first OIS magnetic body;
a second OIS magnetic body disposed in the one of the camera housing and the second carrier;
a second OIS coil disposed in the remaining one of the camera housing and the second carrier and facing the second OIS magnetic body;
an AF ball disposed between the first carrier and the second carrier and configured to guide movement of the first carrier with respect to the second carrier; and
an OIS ball disposed between the second carrier and the camera housing and configured to guide movement of the second carrier with respect to the camera housing,
wherein the first carrier is configured to move in an optical axis direction of the lens through an electromagnetic force acting between the AF magnetic body and the AF coil, and
wherein the second carrier is configured to:
move in a first axis direction perpendicular to an optical axis of the lens through an electromagnetic force acting between the first OIS magnetic body and the first OIS coil; and
move in a second axis direction perpendicular to the first axis through an electromagnetic force acting between the second OIS magnetic body and the second OIS coil.

16. The camera module of claim 1, wherein the reflective member comprises an incident surface facing the lens assembly and an exit surface perpendicular to the incident surface and facing the image sensor, and
wherein, when the cover is viewed from above, the foreign substance trap is at least partially disposed between the exit surface of the reflective member and the image sensor.

17. The camera module of claim 1, further comprising:
an additional reflective member comprising a reflective surface disposed between the reflective member and the side wall of the camera housing, the additional reflective member including an incident surface facing the exit surface of the reflective member, and an exit surface facing the image sensor,
wherein the image sensor is disposed on the support of the camera housing or on a portion of the camera housing facing the support, and faces the exit surface of the additional reflective member.

18. An electronic device comprising a camera module wherein the camera module comprises:
a reflective member comprising a reflective surface comprising an incident surface and an exit surface configured to pass light introduced into the incident surface;
a bracket where the reflective member is disposed;
a camera housing including a support where at least a portion of the bracket is disposed, and a side wall perpendicular to the support portion;
a first carrier disposed in the camera housing and at least partially facing the bracket;
a lens assembly comprising at least one lens facing the incident surface of the reflective member and disposed in the first carrier such that the lens is spaced apart from the reflective member in a direction of an optical axis of the lens;
a cover comprising an opening configured to accommodate a portion of the lens assembly, the cover being coupled to the camera housing;
an image sensor disposed on the camera housing, and configured to receive light that has passed through the exit surface of the reflective member;
a foreign substance trap, at least a portion of which is disposed between the image sensor and the lens assembly when the cover member is viewed from above; and
an adhesive member comprising an adhesive disposed on the foreign substance trap.

19. The electronic device of claim 18, wherein the foreign substance trap is provided in one of the bracket, the first carrier, and the lens assembly.

20. The electronic device of claim 18, wherein, when the cover is viewed from above, at least a portion of the foreign substance trap overlaps the opening.
